(19) United States
(12) Patent Application Publication
(10) Pub. No.: US 2026/0267087 A1
(43) Pub. Date: Sep. 10, 2026

(54) COUPLING DEVICE AND ELECTRONIC DEVICE INCLUDING THE SAME

(71) Applicant: SAMSUNG ELECTRONICS CO., LTD., Suwon-si (KR)

(72) Inventors: Wontaek SEO, Suwon-si (KR); Woosung KIM, Suwon-si (KR); Hyunil BYUN, Suwon-si (KR); Heejin CHOI, Suwon-si (KR)

(73) Assignee: SAMSUNG ELECTRONICS CO., LTD., Suwon-si (KR)

(21) Appl. No.: 19/302,875

(22) Filed: Aug. 18, 2025

(30) Foreign Application Priority Data
Mar. 5, 2025 (KR) 10-2025-0028379

(51) Int. Cl. G02B 6/42

(52) U.S. Cl. CPC G02B 6/4214

(57) ABSTRACT

Provided is a coupling device including a substrate including a light source, the substrate extending in a first direction and a second direction, and having a thickness in a third direction, a first coupling unit, and a second coupling unit, wherein the first coupling unit includes an optical bridge spaced apart from the substrate in the third direction, and a first optical element adjacent to the optical bridge in the first direction, wherein the second coupling unit includes a second optical element between the substrate and the optical bridge, and an optical fiber spaced apart from the first optical element in the first direction, and wherein the light source is configured to output light to be sequentially incident on the second optical element, the optical bridge, the first optical element, and the optical fiber.

### CROSS-REFERENCE TO RELATED APPLICATION

This application is based on and claims priority under 35 U.S.C. §119 to Korean Patent Application No. 10-2025-0028379, filed on Mar. 5, 2025, in the Korean Intellectual Property Office, the disclosure of which is incorporated by reference herein in its entirety.

### BACKGROUND

### 1. Field

The disclosure relates to a coupling device and an electronic device including the same.

### 2. Description of Related Art

Optical interconnect is a technology that converts electrical data into optical signals and transmits the optical signals. Starting with intercontinental (thousands of kilometers) optical communications, optical communication has gradually expanded to shorter distances, such as intercity (tens to hundreds of kilometers), inter-data center (several to tens of kilometers), and inter-rack (tens to several kilometers) connections within a data center. The background of the expansion is the exponentially increasing data transmission demand.

Electrical interconnect transmits charges via conductive copper wires, but there is a problem of decreasing power efficiency due to the skin effect, in which the wire resistance increases as the transmission speed increases. On the other hand, optical interconnect does not have such problems, and thus, has replaced electrical interconnects for long-distance communication as the advantages are clear.

In such optical communication, light transmitted through optical fibers must be converted back into electrical signals, and therefore, various technologies are being explored to connect optical fibers with photonic integrated circuits (PICs) equipped with optical elements for photoelectric conversion.

### SUMMARY

Provided is a coupling device that may connect optical fibers and PICs.

Additional aspects will be set forth in part in the description which follows and, in part, will be apparent from the description, or may be learned by practice of embodiments of the disclosure.

According to an aspect of the disclosure, there is provided a coupling device including a substrate including a light source, the substrate extending in a first direction and a second direction, and having a thickness in a third direction, a first coupling unit including an optical bridge spaced apart from the substrate in the third direction, and a first optical element adjacent to the optical bridge in the first direction, and a second coupling unit including a second optical element between the substrate and the optical bridge, and an optical fiber spaced apart from the first optical element in the first direction, and wherein the light source is configured to output light to be sequentially incident on the second optical element, the optical bridge, the first optical element, and the optical fiber.

The first coupling unit may further include a first member connecting the optical bridge to the first optical element, and the second coupling unit may further include a second member connecting the second optical element to the optical fiber, and each of the first member and the second member may include a contact surface.

The optical bridge and the first optical element may be configured to move together along the contact surface, and the second optical element and the optical fiber may be configured to move together along the contact surface.

The contact surface may be at an angle of 5 degrees to 80 degrees with respect to a plane formed by the second direction and the third direction.

The contact surface may be at an angle of 45 degrees with respect to a plane formed by the second direction and the third direction.

At least one of the first coupling unit and the second coupling unit may be configured to be detachable from and attachable to the substrate.

Each of the first optical element and the second optical element may have positive refractive power.

At least one of the first optical element and the second optical element may be a convex lens or a concave mirror.

The light source may be configured to output the light in the third direction from the substrate.

The substrate may include an edge coupler.

The optical fiber may be at an angle with respect to the second direction.

The light source may be configured to output light from the substrate at an angle with respect to the third direction.

The substrate may include a grating coupler.

Each of the first optical element, the optical bridge, and the second optical element may be disposed at an angle with respect to the third direction.

The first coupling unit may include a plurality of first optical elements, and the second coupling unit may include a plurality of second optical elements and a plurality of optical fibers.

According to an aspect of the disclosure, there is provided an electronic device including a coupling device, an optical fiber array connected to a first end of the coupling device, and an optical integrated circuit connected to a second end of the coupling device opposite to the first end of the coupling device, wherein the coupling device includes a substrate including a light source, the substrate extending in a first direction and a second direction, and having a thickness in a third direction, a first coupling unit including an optical bridge spaced apart from the substrate in the third direction, and a first optical element adjacent to the optical bridge in the first direction, and a second coupling unit including a second optical element between the substrate and the optical bridge, and an optical fiber spaced apart from the first optical element in the first direction, and wherein the light source is configured to output light to be sequentially incident on the second optical element, the optical bridge, the first optical element, and the optical fiber.

The first coupling unit may further include a first member connecting the optical bridge to the first optical element, the second coupling unit may further include a second member connecting the second optical element to the optical fiber, and the first member and the second member may have a contact surface.

The optical bridge and the first optical element may be configured to move together along the contact surface, and the second optical element and the optical fiber may be configured to move together along the contact surface.

The contact surface may be at an angle of 5 degrees to 80 degrees with respect to a plane formed by the second direction and the third direction.

At least one of the first coupling unit and the second coupling unit may be configured to be detachable from and attachable to the substrate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a coupling device according to one or more embodiments;

FIG. 2 is a perspective view showing the detailed structure of the coupling device according to one or more embodiments of FIG. 1;

FIG. 3 is a diagram illustrating an example arrangement of the coupling device of FIG. 1;

FIG. 4 is a diagram illustrating another example arrangement of the coupling device of FIG. 1;

FIG. 5 is a diagram of an example arrangement of the coupling device of FIG. 1 as viewed in the +Z direction;

FIG. 6 is a diagram of another example arrangement of the coupling device of FIG. 1, viewed from the +Z direction;

FIG. 7 is a diagram of another example arrangement of the coupling device of FIG. 1 as viewed from the Z direction;

FIGS. 8 and 9 are diagrams illustrating a structure of a coupling device according to one or more other embodiments;

FIG. 10 is a diagram showing a schematic structure of a coupling device according to one or more other embodiments;

FIG. 11 is a schematic diagram showing the structure of a coupling device according to one or more other embodiments;

FIG. 12 is a schematic diagram showing the structure of a coupling device according to one or more other embodiments;

FIG. 13 schematically illustrates an electronic device according to one or more embodiments; and

FIG. 14 is a schematic diagram showing an electronic device according to one or more other embodiments.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereafter, embodiments of the disclosure will be described more fully with reference to the accompanying drawings. The embodiments of the disclosure are capable of various modifications and may be embodied in many different forms. In the drawings, like reference numerals refer to like elements, and sizes of constituent elements may be exaggerated for clarity and convenience of explanation.

When an element or layer is referred to as being “on” or “above” another element or layer, the element or layer may be directly on another element or layer or intervening elements or layers.

Although the terms “first”, “second”, etc. may be used herein to describe various elements, but these terms are only used to distinguish one element from another. These terms do not limit the material or structure of the constituent elements.

The singular forms include the plural forms unless the context clearly indicates otherwise. When a part “comprises” or “includes” an element in the specification, unless otherwise defined, it is not excluding other elements but may further include other elements.

Also, in the specification, the term “units” or “...modules” denote units or modules that process at least one function or operation, and may be realized by hardware, software, or a combination of hardware and software.

The term “above” and similar directional terms may be applied to both singular and plural.

Operations of all methods described herein may be performed in any suitable order unless otherwise indicated herein or otherwise clearly contradicted by context. The use of any and all examples, or example language (e.g., “such as”) provided herein, is intended merely to better illuminate the disclosure and does not pose a limitation on the scope of the disclosure unless otherwise claimed.

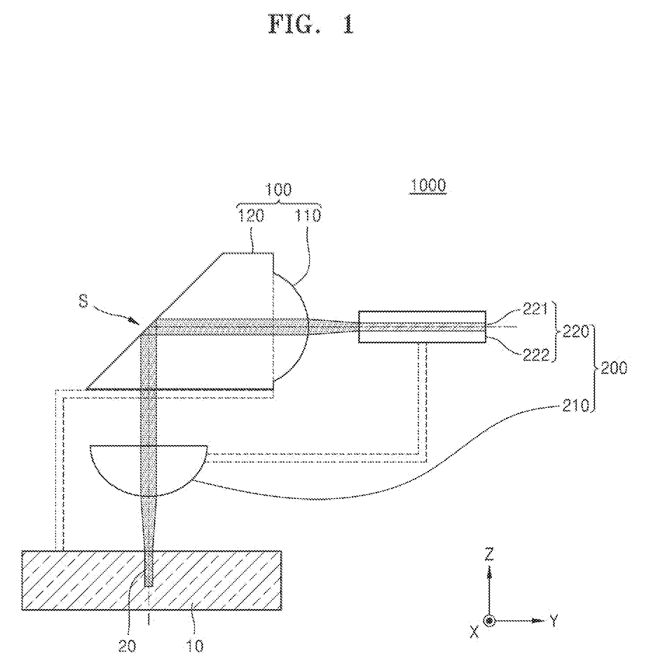

FIG. 1 is a schematic diagram illustrating a structure of a coupling device 1000 according to one or more embodiments.

Referring to FIG. 1, the coupling device 1000 may include a first coupling unit 100 and a second coupling unit 200. The first coupling unit 100 and the second coupling unit 200 may be attached to or detached from a substrate 10. For example, the first coupling unit 100 and the second coupling unit 200 may be detachable and attachable.

The first coupling unit 100 may include a first optical element 110 and an optical bridge 120. The substrate 10 may include at least one light source 20. The substrate 10 may be provided in a first direction (X direction) and a second direction (Y direction), and may have a thickness in a third direction (Z direction). The optical bridge 120 may be spaced apart from the light source 20 in the third direction (Z direction). The optical bridge 120 may include the first optical element 110. The first optical element 110 may be provided in the first direction (X direction) of the optical bridge 120. The first optical element 110 may be an optical element having positive refractive power (e.g., a convex lens or a concave mirror).

The second coupling unit 200 may include a second optical element 210 and an optical fiber 220. The second optical element 210 may be provided between the substrate 10 and the optical bridge 120. The second optical element 210 may be an optical element having positive refractive power (e.g., a convex lens or a concave mirror). The optical fiber 220 may be spaced apart from the first optical element 110 in the first direction (X direction). The optical fiber 220 may include a core 221 having a relatively high refractive index and through which light is transmitted while being totally reflected, and a cladding 222 having a refractive index that is lower than the refractive index of the core 221.

Light output from the light source 20 may be configured to sequentially enter the second optical element 210, the optical bridge 120, the first optical element 110, and the optical fiber 220. For example, the light output from the light source 20 of the substrate 10 may be focused while being transmitted through the second optical element 210 and may enter the optical bridge 120, and the light that enters the optical bridge 120 may be reflected or totally reflected by an inclined surface of the optical bridge 120 and may be directed to the first optical element 110. The light that enters the first optical element 110 may be focused while being transmitted through the first optical element 110 and may enter the core 221 of the optical fiber 220.

A line (dashed line in FIG. 1) connecting the first optical element 110, the optical bridge 120 and the substrate 10 of the first coupling unit 100 indicates that the first optical element 110 and the optical bridge 120 are connected and may move together and may be fixed to the substrate 10. In addition, a line (dashed line in FIG. 1) connecting the second optical element 210 and the optical fiber 220 of the second coupling unit 200 is a virtual line shown for convenience of explanation, and indicates that the second optical element 210 and the optical fiber 220 may be connected and may move together. Hereinafter, the detailed structure of the coupling device 1000 will be described with reference to a perspective view.

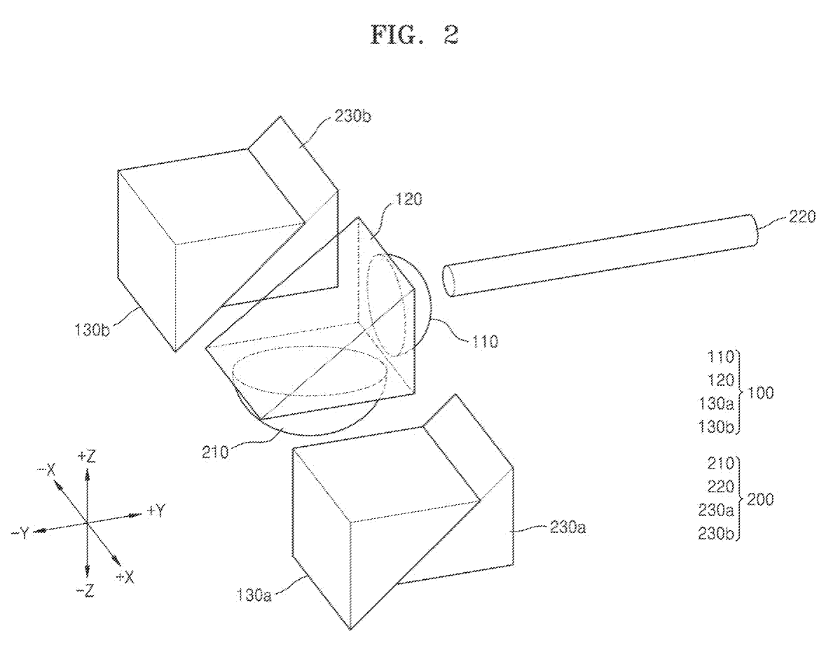

FIG. 2 is a perspective view showing the detailed structure of the coupling device 1000 according to one or more embodiments of FIG. 1.

Referring to FIG. 2, the first coupling unit 100 may include at least one of first members 130a and 130b, and the second coupling unit 200 may include at least one of second members 230a and 230b.

The first members 130a and 130b may be spaced apart from the first optical element 110 and the optical bridge 120. The first members 130a and 130b, for example, may be spaced apart from the first optical element 110 and the optical bridge 120 in the +X direction or the -X direction. The first members 130a and 130b may be attached to the substrate 10 of FIG. 1 or may be detachable from the substrate 10. The first members 130a and 130b may be physically connected to the first optical element 110 and the optical bridge 120 of the first coupling unit 100. The first optical element 110 and the optical bridge 120 of the first coupling unit 100 may move together with the first members 130a and 130b.

The second members 230a and 230b may be spaced apart from the second optical element 210 and the optical fiber 220. The second members 230a and 230b, for example, may be provided apart from the second optical element 210 and the optical fiber 220 in the +X direction or the -X direction. The second members 230a and 230b may be physically connected to the second optical element 210 and the optical fiber 220 of the second coupling unit 200. The second optical element 210 and the optical fiber 220 of the second coupling unit 200 may move together with the second members 230a and 230b.

The first members 130a and 130b and the second members 230a and 230b may have a contact surface. For example, the first members 130a and 130b and the second members 230a and 230b may have a contact surface having an angle of 45 degrees with respect to a Y-Z plane. Each of the first coupling unit 100 and the second coupling unit 200 may move along the contact surface described above. Each of the first coupling unit 100 and the second coupling unit 200 may move at an angle of 45 degrees with respect to the Y-Z plane along the contact surface of the first members 130a and 130b and the second members 230a and 230b. For example, the first optical element 110 and the optical bridge 120 of the first coupling unit 100 may move at an angle of 45 degrees with respect to the Y-Z plane along the contact surface of the first members 130a and 130b and the second members 230a and 230b. In addition, the second optical element 210 and the optical fiber 220 of the second coupling unit 200 may move at an angle of 45 degrees with respect to the Y-Z plane along the contact surface of the first members 130a and 130b and the second members 230a and 230b.

Hereinafter, the arrangement of the coupling device 1000 in the case when the second optical element 210 and the optical fiber 220 of the second coupling unit 200 of the coupling device 1000 of FIG. 1 move downward at an angle of 45 degrees with respect to the Y-Z plane or move upward at an angle of 45 degrees will be described as an example.

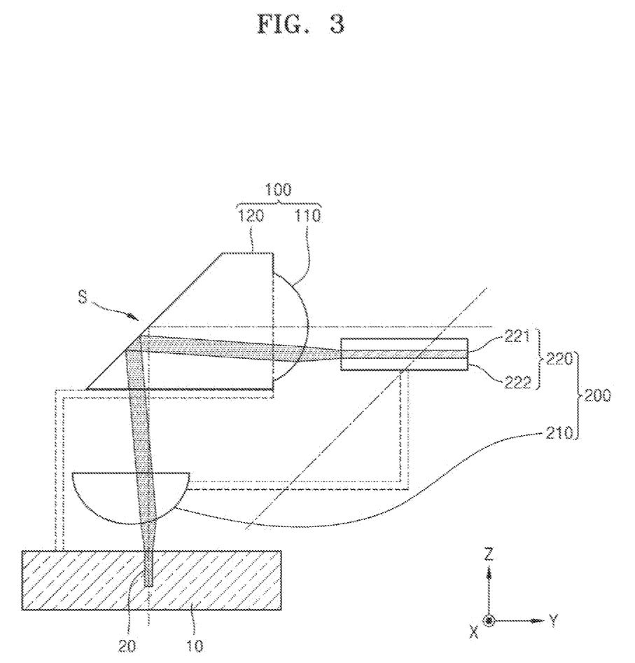

FIG. 3 is a diagram illustrating an example arrangement of the coupling device 1000 of FIG. 1.

Referring to FIG. 3, the second coupling unit 200 may move downward at an angle of 45 degrees with respect to the Y-Z plane along the contact surface of the first members 130a and 130b and the second members 230a and 230b of FIG. 2. The central axis of the second optical element 210 and the central axis of the light source 20 may not be aligned, and the central axes of the optical bridge 120 and the optical fiber 220 may not be aligned. For example, the second optical element 210 may be provided in the -Y direction of the light source 20, and the optical fiber 220 may be provided in the -Z direction of the optical bridge 120.

In this case, compared to FIG. 1, the second optical element 210 of the second coupling unit 200 may be provided at a location spaced apart from the light source 20 in the -Y direction, and light output from the light source 20 may be incident at a location spaced apart in the +Y direction from the center axis of the second optical element 210. When compared to the point where the light transmitted through the second optical element 210 of FIG. 1 is reflected on a reflective surface S, light transmitted through the second optical element 210 of FIG. 3 is reflected at a location spaced apart in the –Y direction and the –Z direction, and compared to the light reflected on the reflective surface S of the optical bridge 120 of FIG. 1, the light reflected on the reflective surface S of the optical bridge 120 of FIG. 3 may be relatively directed toward the –Z direction.

Because the optical fiber 220 of the second coupling unit 200 moves downward at an angle of 45 degrees with respect to the Y-Z plane together with the second optical element 210, the optical fiber 220 of FIG. 3 may be provided at a location spaced apart in the –Z direction relatively compared to the optical fiber 220 of FIG. 1. Accordingly, light reflected from the reflective surface S of the optical bridge 120 of FIG. 3 may be incident on the core 221 of the optical fiber 220.

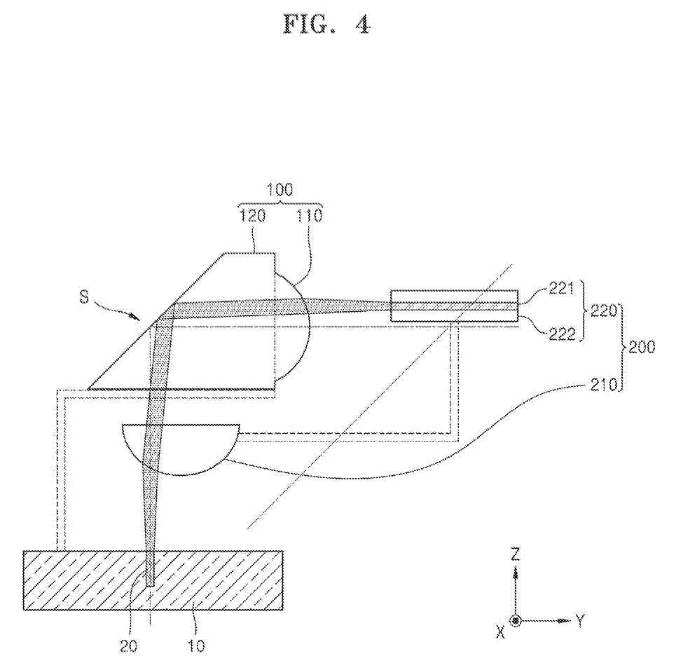

FIG. 4 is a diagram illustrating another example arrangement of the coupling device 1000 of FIG. 1.

Referring to FIG. 4, the second coupling unit 200 may move downward at an angle of 45 degrees with respect to the Y-Z plane along the contact surface of the first members 130a and 130b and the second members 230a and 230b of FIG. 2. The central axis of the second optical element 210 and the central axis of the light source 20 may not be aligned, and the central axes of the optical bridge 120 and the optical fiber 220 may not be aligned. For example, the second optical element 210 may be provided in the +Y direction of the light source 20, and the optical fiber 220 may be provided in the +Z direction of the optical bridge 120.

In this case, compared to FIG. 1, the second optical element 210 of the second coupling unit 200 may be provided at a location spaced apart from the light source 20 in the +Y direction, and light output from the light source 20 may be incident at a location spaced apart in the -Y direction from the central axis of the second optical element 210. Compared to the point where light transmitted through the second optical element 210 of FIG. 1 is reflected on the reflective surface S, light transmitted through the second optical element 210 of FIG. 4 is reflected at a location spaced apart in the +Y direction and the +Z direction, and compared to light reflected on the reflective surface S of the optical bridge 120 of FIG. 1, light reflected on the reflective surface S of the optical bridge 120 of FIG. 4 may relatively direct in the +Z direction.

Because the optical fiber 220 of the second coupling unit 200 moves upward at an angle of 45 degrees with respect to the Y-Z plane together with the second optical element 210, the optical fiber 220 of FIG. 4 may be provided at a location relatively spaced apart in the +Z direction compared to the optical fiber 220 of FIG. 1. Accordingly, light reflected from the reflective surface S of the optical bridge 120 of FIG. 4 may be incident on the core 221 of the optical fiber 220.

The angle of the contact surface of the first members 130a and 130b and the second members 230a and 230b described above of FIG. 2 and the direction in which the first coupling unit 100 and the second coupling unit 200 move are examples for the convenience of explanation, and the angle of the contact surface of the first members 130a and 130b and the second members 230a and 230b may have various angles other than 45 degrees. For example, the angle of the contact surface of the first members 130a and 130b and the second members 230a and 230b may have an angle of 5 degrees to 85 degrees, and the first coupling unit 100 and the second coupling unit 200 may move along the contact surface described above.

According to one or more embodiments, as described with reference to FIGS. 1 to 4, the first coupling unit 100 and the second coupling unit 200 move along the contact surface of the first members 130a and 130b and the second members 230a and 230b, thereby improving the allowable tolerance of the coupling device 1000, improving the coupling efficiency, and providing a coupling device 1000 having a detachable and attachable structure.

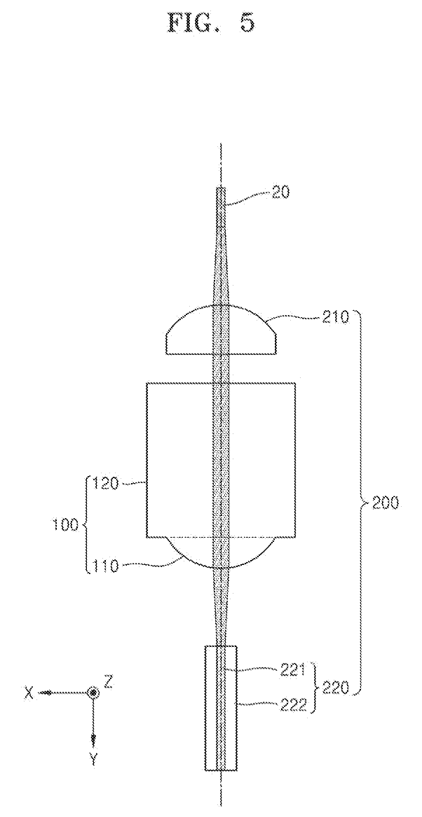

FIG. 5 is a diagram of an example arrangement of the coupling device 1000 of FIG. 1 as viewed in the +Z direction. For convenience of explanation, optical paths of the light source 20 and the second optical element 210 are expanded and shown on the same plane.

Referring to FIG. 5, when the first coupling unit 100 and the second coupling unit 200 are arranged in a straight line, for example, when the light source 20, the second optical element 210, the first optical element 110, and the optical fiber 22 are aligned in a straight line, light output from the light source 20 is incident on the central axis of the second optical element 210, light incident on the second optical element 210 is focused on the central axis of the first optical element 110, and light transmitted through the first optical element 110 may be incident on the core 221 of the optical fiber 220.

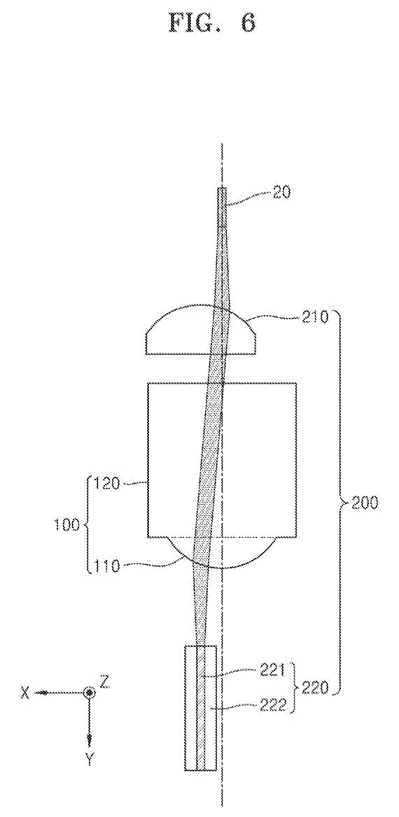

FIG. 6 is a diagram of another example arrangement of the coupling device 1000 of FIG. 1, viewed from the +Z direction. For convenience of explanation, optical paths of the light source 20 and the second optical element 210 are expanded and shown on the same plane.

Referring to FIG. 6, when the second coupling unit 200 is arranged in the +X direction relative to the first coupling unit 100, and when the second optical element 210 and the optical fiber 220 move in the +X direction relative to the first optical element 110 and the light source 20, light output from the light source 20 may be incident on a location spaced apart in the -X direction from the central axis of the second optical element 210. The light incident on a location spaced apart in the -X direction from the central axis of the second optical element 210 may be focused on a location spaced apart in the +X direction from the central axis of the first optical element 110, and light transmitted through the first optical element 110 may be incident on the core 221 of the optical fiber 220 that has moved in the +X direction.

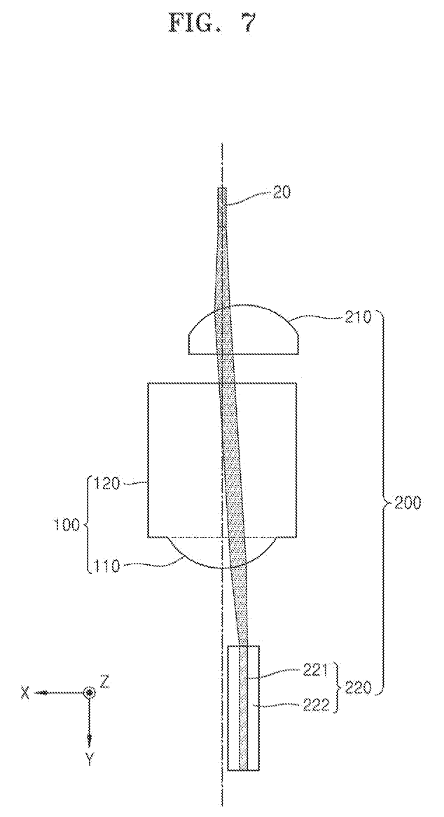

FIG. 7 is a diagram of another example arrangement of the coupling device 1000 of FIG. 1 as viewed from the Z direction. For convenience of explanation, optical paths of the light source 20 and the second optical element 210 are expanded and shown on the same plane.

Referring to FIG. 7, when the second coupling unit 200 is arranged in the -X direction relative to the first coupling unit 100, that is, when the second optical element 210 and the optical fiber 220 are moved in the -X direction relative to the first optical element 110 and the light source 20, light output from the light source 20 may be incident on a location spaced apart from the central axis of the second optical element 210 in the +X direction. The light incident on the location spaced apart from the central axis of the second optical element 210 in the +X direction may be focused on a location spaced apart from the central axis of the first optical element 110 in the -X direction, and the light transmitted through the first optical element 110 may be incident on the core 221 of the optical fiber 220 that has moved in the -X direction.

As described with reference to FIGS. 5 to 7, even when the alignment of the first coupling unit 100 and the second coupling unit 200 is misaligned in the X direction, light emitted from the light source 20 may be incident on the core 221 of the optical fiber 220, and thus, the allowable tolerance of the coupling device 1000 may be improved and the coupling efficiency may be improved.

An example in which the light output from the light source 20 of the substrate 10 is incident on the optical fiber 220 through the second optical element 210, the optical bridge 120, and the first optical element 110 has been described, but embodiments are not limited thereto, and light emitted from the optical fiber 220 may be input to the substrate 10 through the first optical element 110, the optical bridge 120, and the second optical element 210.

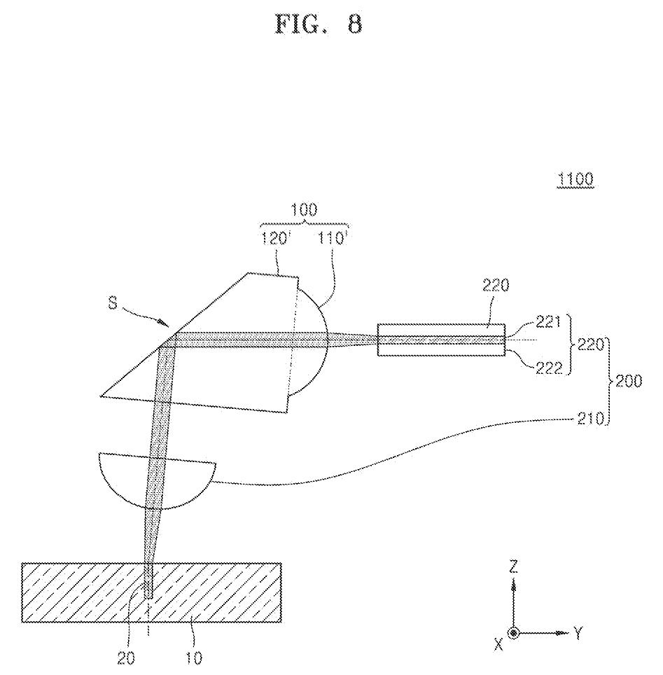

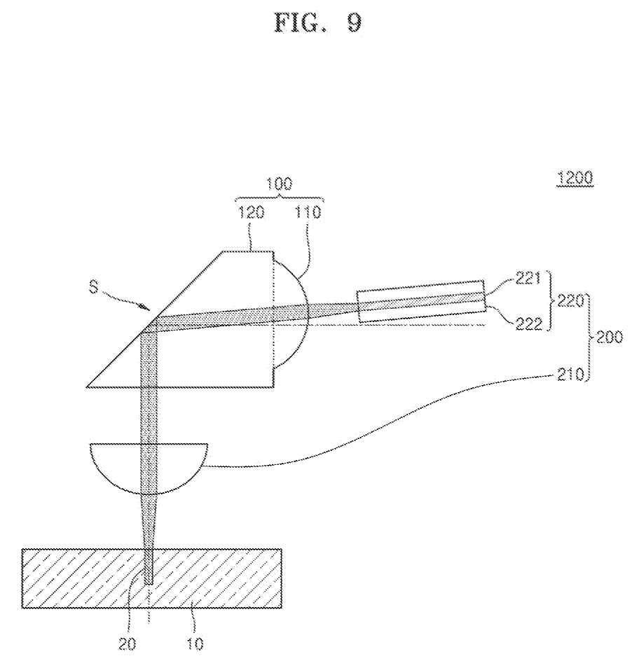

FIGS. 8 and 9 are diagrams showing a structure of coupling devices 1100 and 1200 according to one or more other embodiments. The description will be mainly focused on differences with reference to FIG. 1, and the same reference numerals indicate the same components.

Referring to FIG. 8, compared to FIG. 1, light output from a light source 20 of the coupling device 1100 may travel obliquely in a direction perpendicular to one surface of a substrate 10 (for example, in the Z direction), and the central axis of a second optical element 210’ may be provided obliquely with respect to the Z direction. Because the central axes of a first optical element 110’ and an optical bridge 120’ are provided obliquely, light output from the light source 20 may be incident on a core 221 of an optical fiber 220 through the second optical element 210’, the optical bridge 120’, and the first optical element 110’. At this time, the reflective surface S of the optical bridge 120’ may be provided at an angle less than 45 degrees and corresponding to an angle that the central axis of the second optical element 210’ is inclined at with respect to the Z direction.

Referring to FIG. 9, compared to FIG. 1, an optical fiber 220’ of the coupling device 1200 may be provided obliquely with respect to a direction (for example, the Y direction) parallel to one surface of the substrate 10. In this case, the reflective surface S of the optical bridge 120 may be provided at an angle greater than 45 degrees by an angle that the central axis of the optical fiber 220’ makes with the Y direction.

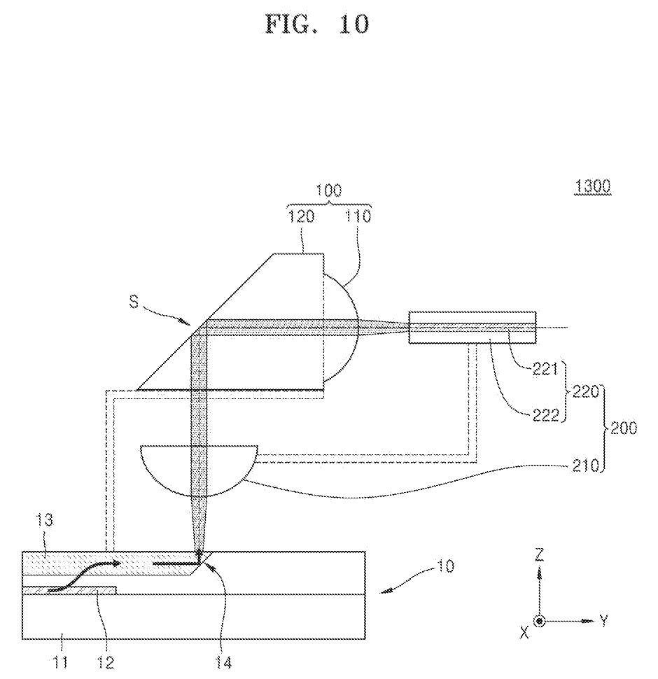

FIG. 10 is a diagram illustrating a structure of a coupling device 1300 according to one or more other embodiments. Referring to FIG. 1, the description will be mainly focused on differences, and the same components are indicated by the same reference numerals.

Referring to FIG. 10, the coupling device 1300 may include a buried oxide layer (BOX) layer 11 provided on the substrate 10, a Si waveguide 12 provided on the BOX layer 11, and a silicon nitride (SiN) waveguide 13 provided on the silicon (Si) waveguide 12. Light output from the light source may travel along the Si waveguide 12 and be coupled to the SiN waveguide 13, and the travelling direction of the light traveling along the SiN waveguide 13 may be changed by an inclined cross-section of an edge coupler 14 provided at one end of the SiN waveguide 13 and the light may be output in a direction perpendicular to a surface of the substrate 10 (for example, the Z direction).

Light output from the substrate 10 by the edge coupler 14 may be incident along the central axis of the second optical element 210, and the light transmitted along the central axis of the second optical element 210 may be reflected on the reflective surface S of the optical bridge 120 and be incident along the central axis of the first optical element 110, and the light transmitted through the first optical element 110 can be incident on the core 221 of the optical fiber 220.

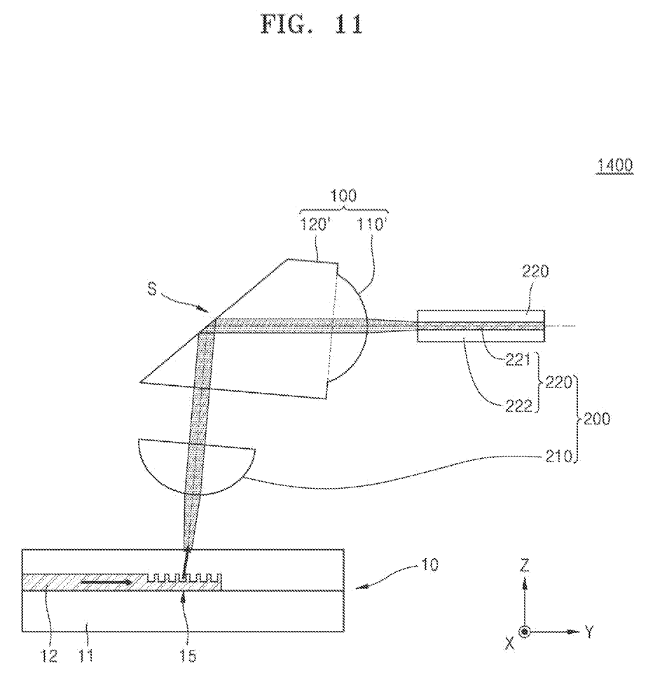

FIG. 11 is a diagram illustrating the structure of a coupling device 1400 according to one or more other embodiments. Referring to FIG. 8, the description will be mainly focused on differences, and the same components are indicated by the same reference numerals.

Referring to FIG. 11, the coupling device 1400 may include the waveguide 12 provided on the substrate 10 and a grating coupler 15 provided at one end of the waveguide 12. Light output from a light source may be obliquely output at an angle with respect to a surface of the substrate 10 (for example, an angle tilted by approximately 7 to 8 degrees with respect to the Z axis). In this case, as described with reference to FIG. 8, the second optical element 210’, a central axis of the first optical element 110’, and a central axis of the optical bridge 120’ may be arranged to be inclined with respect to the Z axis, and the reflective surface S of the optical bridge 120’ may be arranged at an angle less than 45 degrees with respect to the X-axis (for example, an angle inclined by 7 to 8 degrees with respect to 45 degrees).

Light obliquely output from the substrate 10 by the grating coupler 15 may be incident along the central axis of the second optical element 210, and light transmitted along the central axis of the second optical element 210 may be reflected on the reflective surface S of the optical bridge 120 and incident along the central axis of the first optical element 110, and light transmitted through the first optical element 110 may be incident on the core 221 of the optical fiber 220.

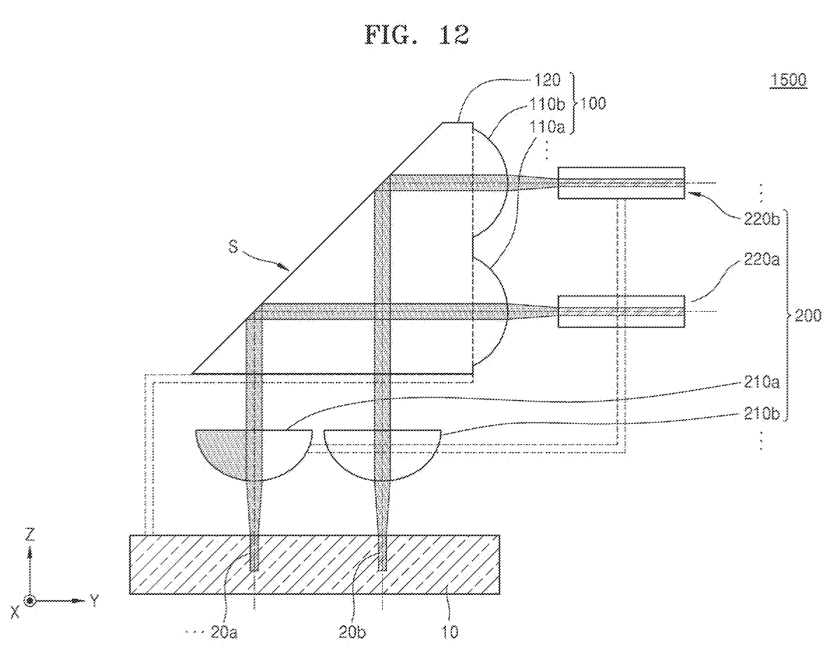

FIG. 12 is a diagram illustrating a structure of a coupling device 1500 according to one or more other embodiments. Referring to FIG. 1, the description will be mainly focused on differences, and the same components are indicated by the same reference numerals.

Referring to FIG. 12, the coupling device 1500 may have a multilayer structure. For example, the coupling device 1500 may include a plurality of light sources 20a, 20b,..., the first coupling unit 100 of the coupling device 1500 may include a plurality of first optical elements 110a, 110b,... and the optical bridge 120, and the second coupling unit 200 of the coupling device 1500 may include a plurality of second optical elements 210a, 210b,.... and a plurality of optical fibers 220a, 220b,....

For example, the plurality of light sources 20a, 20b,... may include N x M light sources arranged in an N x M array, the first optical elements 110a, 110b,... may include N x M optical elements arranged in an N x M array, the second optical elements 210a, 210b,... may include N x M optical elements arranged in an N x M array, and the plurality of optical fibers 220a, 220b,... may include N x M optical fibers arranged in an N x M array.

The plurality of first optical elements 110a, 110b,... and the optical bridge 120 of the first coupling unit 100 may be physically connected to move together and attachable to the substrate 10, and the plurality of second optical elements 210a, 210b,... and the plurality of optical fibers 220a, 220b,... of a second coupling unit 200 may be physically connected to move together.

Light output from the plurality of light sources 20a, 20b,... may be incident on the plurality of optical fibers 220a, 220b,..., respectively. For example, light emitted from a first light source 20a may be incident on the core of a first optical fiber 220a through a 2-1 optical element 210a, the optical bridge 120, and a 1-1 optical element 110a, and light emitted from a second light source 20b may be incident on the core of a second optical fiber 220b through a 2-2 optical element 210b, the optical bridge 120, and a 1-2 optical element 112a.

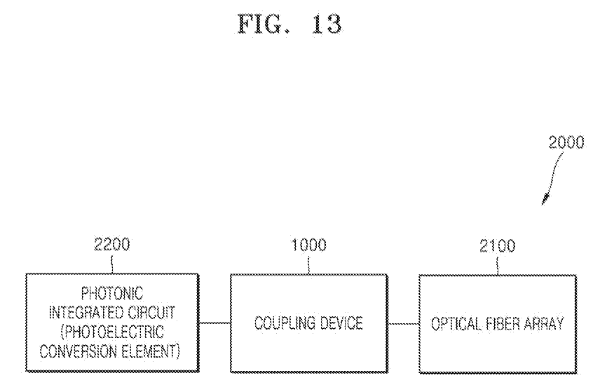

FIG. 13 illustrates a block diagram of an electronic device 2000 according to one or more embodiments.

The electronic device 2000 may include the coupling device 1000, an optical fiber array 2100 and a photonic integrated circuit 2200 connected to each side of the coupling device 1000.

The coupling device 1000 may include any one of the coupling devices 1000, 1100, 1200, 1300, 1400, and 1500 described above, or a coupling device having a combination or modified structure thereof. The optical fiber array 2100 includes a plurality of optical fibers, and output terminals of the optical fibers may be respectively coupled to terminals arranged in a plurality of rows at one end of the coupling device 1000.

The photonic integrated circuit 2200 may include a plurality of photoelectric conversion elements that convert light into electrical signals and may include planar type waveguides that transmit light transmitted through the coupling device 1000 to each of the plurality of photoelectric conversion elements.

Such an electronic device 2000 may be utilized for memory-to-memory communication, XPU (e.g., central processing unit (CPU) and graphic processing unit (GPU), etc.)-to-memory communication, or XPU-to-XPU data transmission.

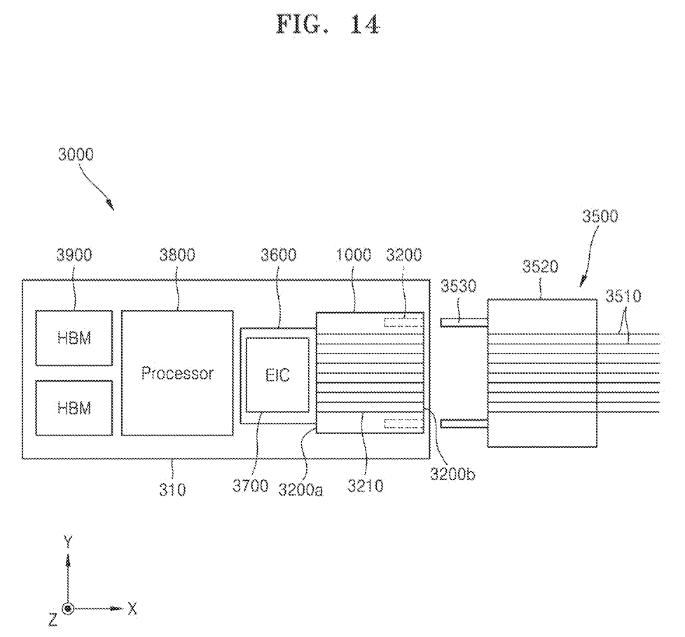

FIG. 14 illustrates an electronic device 3000 according to one or more other embodiments.

The electronic device 3000 may be a processor unit package. The electronic device 3000 may include a circuit board 3100, a photonic integrated circuit 3600 formed on the circuit board 3100, a coupling device 1000, a driving circuit (EIC) 3700 for driving the photonic integrated circuit 3600, a processor 3800, and a memory 3900. The memory 3900 may be a high bandwidth memory (HBM). In addition, the electronic device 3000 may further include an input interface, an output interface, etc.

The coupling device 1000 includes a plurality of coupling waveguides 3210, and one end 3200a of the coupling device 1000 may be connected to a photonic integrated circuit 3700, and the other end 3200b may be connected to an optical fiber array 3500. The optical fiber array 3500 includes a plurality of optical fibers 3510, and the output terminals of the plurality of optical fibers 3510 may be arranged in a two-dimensional manner, that is, on a plane parallel to the YZ plane, in a plurality of rows with different positions in the Z direction. The output terminals arranged two-dimensionally in this way may be coupled with the ends of the coupling waveguides 3210 arranged two-dimensionally in accordance with each other. The optical fiber array 3500 may also be equipped with guide pins 3530 to be coupled to the guide pin holes 3200 of the coupling device 1000.

Light from the optical fiber array 3500 input to the coupling device 1000 in this manner may pass through the coupling waveguide 3210 and be transmitted to a plurality of planar type waveguides provided in the photonic integrated circuit 3600, and may be incident on the photoelectric conversion elements through the coupling waveguide. The light may be converted into an electric signal by the photoelectric conversion elements.

The coupling device according to one or more embodiments may include a substrate including at least one light source, and provided in a first direction and a second direction and having a thickness in a third direction, a first coupling unit, and a second coupling unit. The first coupling unit may include an optical bridge spaced apart from the substrate in the third direction, and at least one first optical element provided in the first direction of the optical bridge. The second coupling unit may include at least one second optical element provided between the substrate and the optical bridge, and at least one optical fiber provided spaced apart from the first optical element in the first direction. Light output from the at least one light source may be configured to be sequentially incident in the at least one second optical element, the optical bridge, the at least one first optical element, and the at least one optical fiber.

The first coupling unit may include a first member connecting the optical bridge to the at least one first optical element, and the second coupling unit includes a second member connecting the at least one second optical element to the at least one optical fiber. The first member and the second member may have a contact surface.

The optical bridge and the at least one first optical element may be configured to move together along the contact surface, and the at least one second optical element and the at least one optical fiber may be configured to move together along the contact surface.

The contact surface may form an angle of 5 degrees to 80 degrees with a plane formed by the second direction and the third direction.

The contact surface may form an angle of 45 degrees with a plane formed by the second direction and the third direction.

At least one of the first coupling unit and the second coupling unit may be configured to be detachable from and attachable to the substrate.

The at least one first optical element and the at least one second optical element may be optical elements having positive refractive power.

The at least one first optical element and the at least one second optical element may be one of a convex lens and a concave mirror.

Light output from the at least one light source may be output from the substrate in the third direction.

The substrate may include an edge coupler.

The at least one optical fiber may be provided obliquely with respect to the second direction.

Light output from the at least one light source may be output obliquely with respect to the third direction from the substrate.

The substrate may include a grating coupler.

The at least one first optical element, the optical bridge, and at least one second optical element may be provided obliquely with respect to the third direction.

The first coupling unit may include a plurality of first optical elements, and the second coupling unit may include a plurality of second optical elements and a plurality of optical fibers.

(The electronic device according to one or more embodiments may include a coupling device, an optical fiber array connected to one end of the coupling device, and an optical integrated circuit connected to the other end of the coupling device. The coupling device may include at least one light source, a substrate provided in the first direction and the second direction and having a thickness in the third direction, a first coupling unit, and a second coupling unit. The first coupling unit may include an optical bridge spaced apart from the substrate in the third direction, and at least one first optical element provided in the first direction of the optical bridge. The second coupling unit may include at least one second optical element provided between the substrate and the optical bridge, and at least one optical fiber spaced apart from the first optical element in the first direction. Light output from the at least one light source may be configured to be sequentially incident in the at least one second optical element, the optical bridge, the at least one first optical element, and the at least one optical fiber.

The first coupling unit may include a first member connecting the optical bridge to the at least one first optical element, and the second coupling unit may include a second member connecting the at least one second optical element to the at least one optical fiber. The first member and the second member may have a contact surface.

The optical bridge and the at least one first optical element may be configured to move together along the contact surface, and the at least one second optical element and the at least one optical fiber may be configured to move together along the contact surface.

The contact surface may form an angle of 5 degrees to 80 degrees with a plane formed by the second direction and the third direction.

At least one of the first coupling unit and the second coupling unit may be configured to be detachable from the substrate.

The coupling device according to one or more embodiments may provide a coupling device having an extended tolerance, improved coupling efficiency, and a detachable and attachable structure.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. A coupling device comprising:
a substrate comprising a light source, the substrate extending in a first direction and a second direction, and having a thickness in a third direction;
a first coupling unit comprising:
an optical bridge spaced apart from the substrate in the third direction; and
a first optical element adjacent to the optical bridge in the first direction; and
a second coupling unit comprising:
a second optical element between the substrate and the optical bridge; and
an optical fiber spaced apart from the first optical element in the first direction,
wherein the light source is configured to output light to be sequentially incident on the second optical element, the optical bridge, the first optical element, and the optical fiber.

2. The coupling device of claim 1, wherein the first coupling unit further comprises a first member connecting the optical bridge to the first optical element,
wherein the second coupling unit further comprises a second member connecting the second optical element to the optical fiber, and
wherein each of the first member and the second member comprises a contact surface.

3. The coupling device of claim 2, wherein the optical bridge and the first optical element are configured to move together along the contact surface, and
wherein the second optical element and the optical fiber are configured to move together along the contact surface.

4. The coupling device of claim 2, wherein the contact surface is at an angle of 5 degrees to 80 degrees with respect to a plane formed by the second direction and the third direction.

5. The coupling device of claim 2, wherein the contact surface is at an angle of 45 degrees with respect to a plane formed by the second direction and the third direction.

6. The coupling device of claim 1, wherein at least one of the first coupling unit and the second coupling unit is configured to be detachable from and attachable to the substrate.

7. The coupling device of claim 1, wherein each of the first optical element and the second optical element has positive refractive power.

8. The coupling device of claim 1, wherein at least one of the first optical element and the second optical element is a convex lens or a concave mirror.

9. The coupling device of claim 1, wherein the light source is configured to output the light in the third direction from the substrate.

10. The coupling device of claim 1, wherein the substrate comprises an edge coupler.

11. The coupling device of claim 1, wherein the optical fiber is at an angle with respect to the second direction.

12. The coupling device of claim 1, wherein the light source is configured to output light from the substrate at an angle with respect to the third direction.

13. The coupling device of claim 12, wherein the substrate comprises a grating coupler.

14. The coupling device of claim 12, wherein each of the first optical element, the optical bridge, and the second optical element is disposed at an angle with respect to the third direction.

15. The coupling device of claim 1, wherein the first coupling unit comprises a plurality of first optical elements, and
wherein the second coupling unit comprises a plurality of second optical elements and a plurality of optical fibers.

16. An electronic device comprising:
a coupling device;
an optical fiber array connected to a first end of the coupling device; and
an optical integrated circuit connected to a second end of the coupling device opposite to the first end of the coupling device,
wherein the coupling device comprises:
a substrate comprising a light source, the substrate extending in a first direction and a second direction, and having a thickness in a third direction;
a first coupling unit comprising:
an optical bridge spaced apart from the substrate in the third direction; and
a first optical element adjacent to the optical bridge in the first direction; and
a second coupling unit comprising:
a second optical element between the substrate and the optical bridge; and
an optical fiber spaced apart from the first optical element in the first direction,
wherein the light source is configured to output light to be sequentially incident on the second optical element, the optical bridge, the first optical element, and the optical fiber.

17. The electronic device of claim 16, wherein the first coupling unit further comprises a first member connecting the optical bridge to the first optical element,
wherein the second coupling unit further comprises a second member connecting the second optical element to the optical fiber, and
wherein the first member and the second member have a contact surface.

18. The electronic device of claim 17, wherein the optical bridge and the first optical element are configured to move together along the contact surface, and the second optical element and the optical fiber are configured to move together along the contact surface.

19. The electronic device of claim 17, wherein the contact surface is at an angle of 5 degrees to 80 degrees with respect to a plane formed by the second direction and the third direction.

20. The electronic device of claim 16, wherein at least one of the first coupling unit and the second coupling unit is configured to be detachable from and attachable to the substrate.
